(19) United States
(12) Patent Application Publication
(10) Pub. No.: US 2026/0341610 A1
(43) Pub. Date: Oct. 29, 2026

(54) KEYBOARD DEVICE

(71) Applicant: KABUSHIKI KAISHA TOKAI RIKA DENKI SEISAKUSHO, Aichi (JP)

(72) Inventor: Yosuke HATADA, Aichi (JP)

(73) Assignee: KABUSHIKI KAISHA TOKAI RIKA DENKI SEISAKUSHO, Aichi (JP)

(21) Appl. No.: 19/650,724

(22) Filed: Apr. 17, 2026

(30) Foreign Application Priority Data
Apr. 25, 2025 (JP) 2025-072804

(51) Int. Cl. H01H 13/84; H01H 13/48; H01H 13/86

(52) U.S. Cl. CPC H01H 13/84; H01H 13/48; H01H 13/86

(57) ABSTRACT

The keyboard device including: a top plate with a plurality of key switches attached to an upper surface thereof; a bottom cover provided on a lower surface side of the top plate and constituting a chassis on a lower side; and a gasket configured to hold the upper surface and the lower surface using a holding portion provided inside a bottom surface of the bottom cover, in which a boss structure extending in a thickness direction of the chassis is provided on the lower surface of the top plate, and an abutting portion that abuts against the upper surface of the gasket is provided on the outside of the boss structure.

### CROSS REFERENCE TO RELATED APPLICATION(S)

This application is based upon and claims benefit of priority from Japanese Patent Application No. 2025-072804, filed on April 25, 2025, the entire contents of which are incorporated herein by reference.

### BACKGROUND

The present invention relates to a keyboard device.

Keyboard devices are widely used as input devices for entering information into computers. By pressing each of key switches arranged on the keyboard device, the user can input information corresponding to each key switch into the computer.

For example, CN219370861U discloses a keyboard device using a double layer buffer structure. Specifically, CN219370861U discloses that two elastic arms attached in an upward/downward direction to an outer wall of the keyboard device give elasticity to a PCB plate that receives a pressing shaft. According to this, the keyboard device disclosed in CN219370861U can reduce feedback power when pressing the key switches, thereby reducing fatigue felt by users who use it for long periods of time.

### SUMMARY

However, in the keyboard device disclosed in CN219370861U, since the elastic arm is attached to the outer wall of the keyboard device, the typing feel of the key switches sometimes changes between near the outer wall and near the center of the keyboard device.

Accordingly, in order to further improve the operation experience of users of keyboard devices, it was necessary to make the typing feel of the key switches more consistent.

Here, in consideration of the above-mentioned problems, the present invention is directed to providing a new and improved keyboard device that can make the typing feel of key switches more uniform.

To solve the above-described problem, according to an aspect of the present disclosure, there is provided a keyboard device including: a top plate with a plurality of key switches attached to an upper surface thereof; a bottom cover provided on a lower surface side of the top plate and constituting a chassis on a lower side; and a gasket configured to hold the upper surface and the lower surface using a holding portion provided inside a bottom surface of the bottom cover, in which a boss structure extending in a thickness direction of the chassis is provided on the lower surface of the top plate, and an abutting portion that abuts against the upper surface of the gasket is provided on the outside of the boss structure.

According to the present invention as described above, it is possible to make the typing feel of the key switches more uniform.

### BRIEF DESCRIPTION OF THE DRAWINGS

FIG. 1 is a longitudinal cross-sectional view showing a cross-sectional configuration of a keyboard device according to an embodiment of the present invention.

FIG. 2 is a plan view showing a planar configuration of the keyboard device according to the embodiment.

FIG. 3 is a perspective view showing a shape of an abutting portion.

FIG. 4 is a perspective view showing an aspect in which a cap and the abutting portion pinch a gasket.

FIG. 5 is a perspective view showing a structure of a holding portion configured to hold the gasket.

### DETAILED DESCRIPTION OF THE EMBODIMENT(S)

A preferred embodiment of the present disclosure will be described in detail below with reference to the accompanying drawings. In the specification and the drawings, structural elements having substantially the same functional configuration are denoted by the same reference numerals, and redundant description thereof will be omitted.

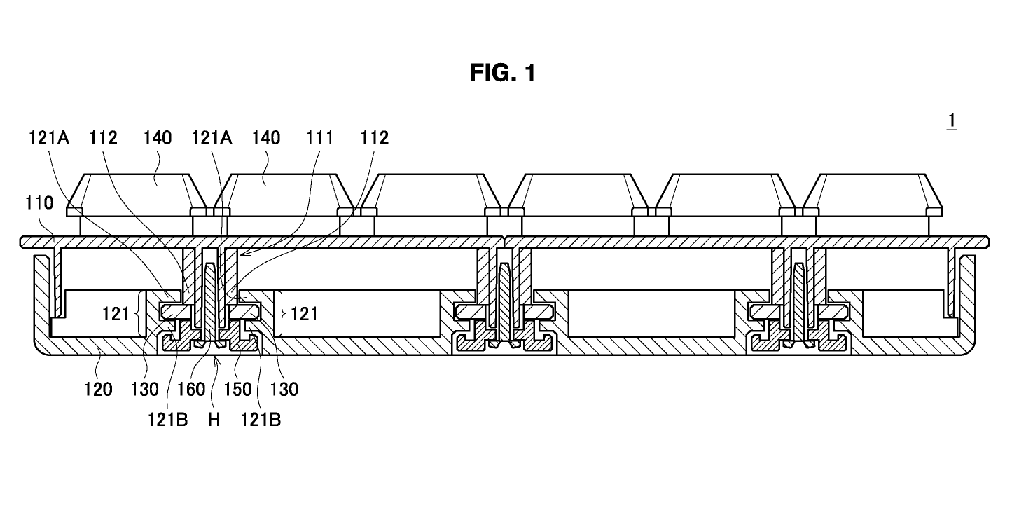

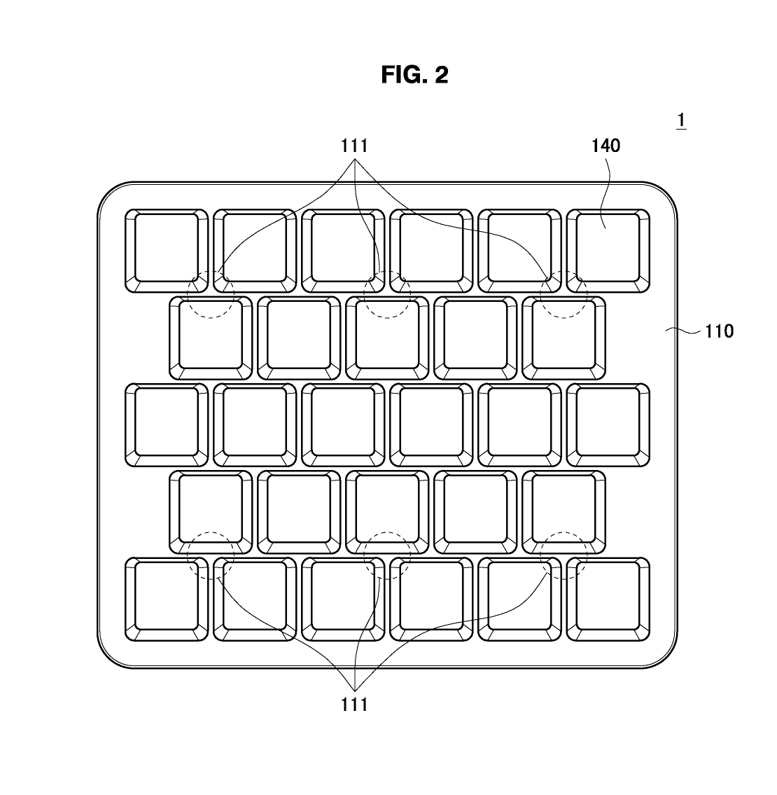

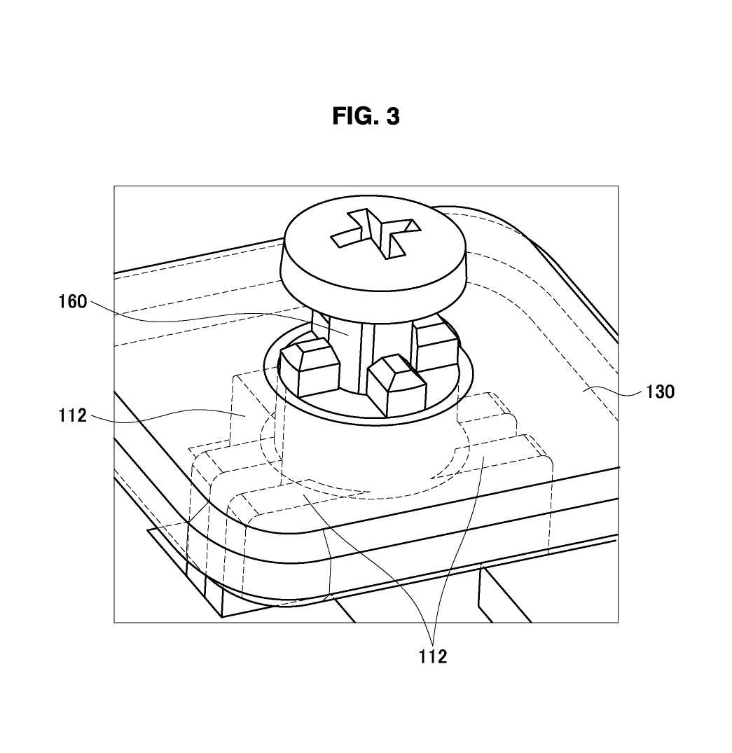

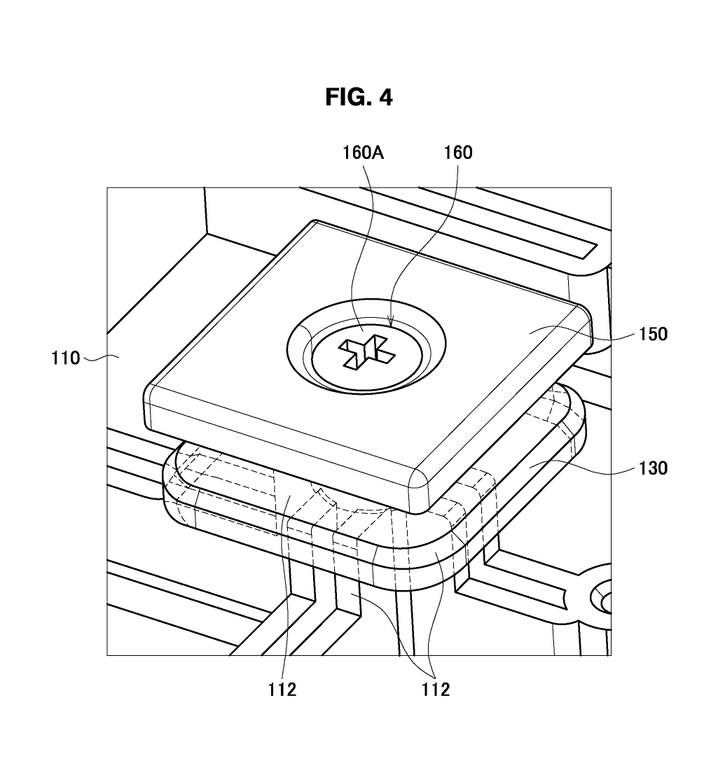

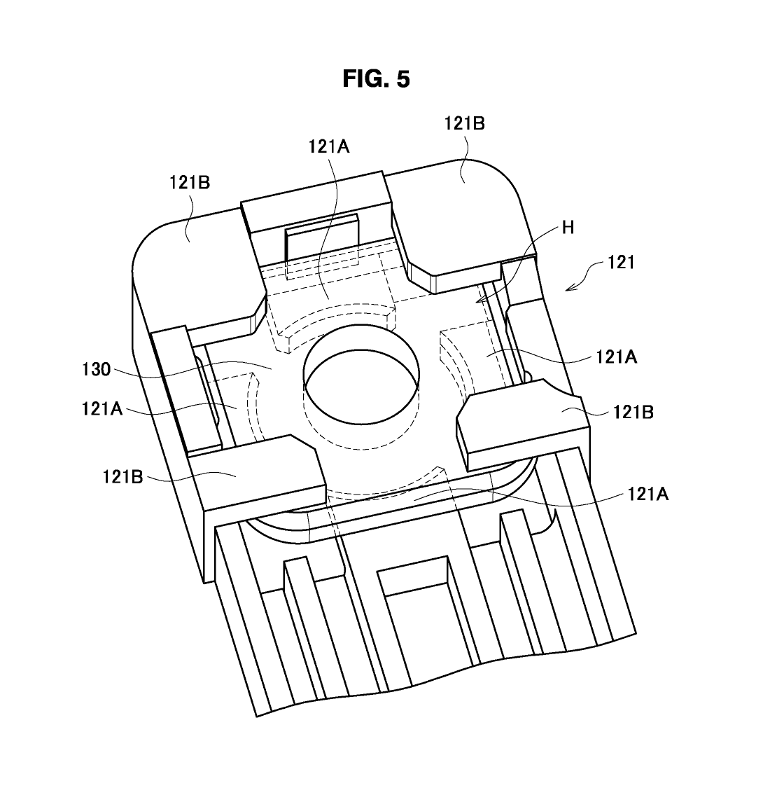

Referring to FIG. 1 to FIG. 5, a structure of a keyboard device according to an embodiment of the present invention will be described. FIG. 1 is a longitudinal cross-sectional view showing a cross-sectional configuration of a keyboard device 1 according to the embodiment. FIG. 2 is a plan view showing a planar configuration of the keyboard device 1 according to the embodiment. FIG. 3 is a perspective view showing a shape of an abutting portion 112. FIG. 4 is a perspective view showing an aspect in which a cap 150 and the abutting portion 112 pinch a gasket 130. FIG. 5 is a perspective view showing a structure of a holding portion 121 configured to hold the gasket 130. FIG. 3 to FIG. 5 show the shapes of a fixed portion 160, the cap 150, the gasket 130, the abutting portion 112, and the like, as viewed from the side of a bottom cover 120.

As shown in FIG. 1, the keyboard device 1 includes key switches 140, a top plate 110, the bottom cover 120, the gasket 130, the cap 150, and the fixed portion 160.

The key switches 140 include key caps, which are parts that a user touches directly with their fingers, and when the user pushes the key caps, they transition from an off state to an on state independently of each other. For example, the key switches 140 may transition from the off state to the on state by detecting a push of the key cap with a magnetic sensor. In addition, the key switches 140 may include a spring that pushes back a pushed key cap with a repulsion force, and may transition from the on state to the off state independently of each other when a magnetic sensor detects that the key cap has been released from the push. According to this, the keyboard device 1 can accept information corresponding to the key switches 140 that have transitioned to the on state as input from the user.

As shown in FIG. 2, the key switches 140 have a rectangular planar shape and may be arranged two-dimensionally in upward, downward, leftward and rightward directions when viewed from the front in FIG. 2. Specifically, the key switches 140 may be arranged in a straight line in the leftward/rightward direction as viewed in FIG. 2, or may be arranged in a line offset in the upward/downward direction as viewed in FIG. 2. That is, the key switches 140 may be arranged two-dimensionally such that the key switches 140 arranged in a line in the leftward/rightward direction are staggered in the upward/downward direction. Alternatively, the key switches 140 may be arranged two-dimensionally such that the key switches 140 arranged in a straight line in the leftward/rightward direction are offset in the upward/downward direction by less than a width of one of the key switches 140.

However, the key switches 140 may be arranged in a two-dimensional matrix in a straight line in the leftward/rightward direction and in the upward/downward direction, or may be arranged in a curved line in a two-dimensional arrangement in accordance with human engineering (ergonomics).

The top plate 110 is a plate-shaped member that extends across the entire surface of the keyboard device 1, and the plurality of key switches 140 are attached to the upper surface of the top plate 110 in the two-dimensional arrangement shown in FIG. 2. The top plate 110 functions as a support plate that receives the push pressure from the key switches 140 when the key switches 140 are pushed by the user. The top plate 110 may be made of a metal such as aluminum or steel, or may be made of an organic resin such as polycarbonate or the like.

A boss structure 111 is provided on the lower surface of the top plate 110 opposite to the upper surface thereof, and extends in a normal direction of the lower surface of the top plate 110 (i.e., in a thickness direction of the chassis of the keyboard device 1). The boss structure 111 is a cylindrical protrusion structure that protrudes from the lower surface of the top plate 110. The boss structure 111 functions as a support structure that supports the top plate 110 in the thickness direction of the chassis of the keyboard device 1, and also functions as a fixing structure and a positioning structure between the top plate 110 and the bottom cover 120.

The fixed portion 160 is inserted into the cylindrical inside of the boss structure 111 and fixed therein. Accordingly, the cap 150 is fixed to the boss structure 111 by the fixed portion 160, thereby assembling the cap 150 to the top plate 110. The cap 150 can assemble the gasket 130 and the bottom cover 120 to the top plate 110 by pinching the gasket 130 and the bottom cover 120 between the cap 150 and the top plate 110. The fixed portion 160 may be fixed to the boss structure 111 by screwing into a screw groove provided on the inside of the cylindrical shape of the boss structure 111, by fitting into a claw hole or a pin hole provided on the inside of the cylindrical shape of the boss structure 111, or by sliding against the inside of the cylindrical shape of the boss structure 111.

The boss structure 111 is not limited to a peripheral edge portion of the top plate 110, but can be provided at any arbitrary position including a central portion of the top plate 110, etc. For example, as shown in FIG. 2, the boss structure 111 may be provided at a position corresponding to the space between the key switches 140 arranged two-dimensionally on the upper surface of the top plate 110. For example, when the key switches 140 are arranged in a straight line in the leftward/rightward direction and arranged in a line shifted in the upward/downward direction, the boss structure 111 may be provided at a position corresponding to the space between two of the key switches 140 arranged in the leftward/rightward direction, or may be provided at a position corresponding to the space between three of the key switches 140 shifted and arranged in the upward/downward direction.

In addition, when the key switches 140 are arranged in a line in the leftward/rightward direction and the upward/downward direction, respectively, the boss structure 111 may be provided at a position corresponding to the space between two of the key switches 140 arranged in the leftward/rightward direction, or may be provided at a position corresponding to the space between four of the key switches 140 arranged in the upward/downward direction and the leftward/rightward direction.

The abutting portion 112 protruding from the lower surface of the top plate 110 is provided outside the boss structure 111. As shown in FIG. 3, the abutting portion 112 may be a ridgeline-like rib structure that extends radially from the boss structure 111 as a center. The abutting portion 112 abuts against the gasket 130 provided below the top plate 110, thereby transmitting the push pressure from the key switches 140 to the gasket 130.

The abutting portion 112 may be a rib structure that extends between the key switches 140. For example, when the boss structure 111 is provided at a position corresponding to the space between the two key switches 140, the abutting portion 112 may be a rib structure extending in two directions in a straight line across the boss structure 111. In addition, when the boss structure 111 is provided at a position corresponding to the space between the three key switches 140, the abutting portion 112 may be a rib structure extending in three directions: two directions extending linearly on either side of the boss structure 111, and one direction extending perpendicular to the two directions. Further, when the boss structure 111 is provided at a position corresponding to the space between the four key switches 140, the abutting portion 112 may be a rib structure extending in four directions, including two directions extending linearly across the boss structure 111, and two directions extending perpendicular to the two directions. When the abutting portion 112 is a rib structure that extends in more directions, the top plate 110 can abut against the gasket 130 in more directions and over a wider range. Accordingly, the top plate 110 can transmit the push pressure from the key switches 140 to the gasket 130 more efficiently.

However, the abutting portion 112 may have a structure other than a rib structure. For example, the abutting portion 112 may be a cylindrical protrusion structure provided outside the boss structure 111 with the boss structure 111 at its center.

The gasket 130 is a flexible member having an annular structure made of rubber, urethane, elastomer, or the like. The boss structure 111 passes through the inside of the annular structure of the gasket 130, and the gasket 130 is provided on the outside of the boss structure 111. The gasket 130 is pinched between the abutting portion 112 and the cap 150 by abutting its upper surface to the abutting portion 112 of the top plate 110 and abutting its lower surface to the cap 150 as described below. This allows the gasket 130 to buffer the push pressure from the key switches 140 between the abutting portion 112 of the top plate 110 and the cap 150 through flexible deformation. Accordingly, the gasket 130 can improve the hardness, sound, bounce, or thumping when the user pushes the key switches 140.

The cap 150 is provided to cover the tip of the boss structure 111 and abuts against the lower surface of the gasket 130. The cap 150 may abut the lower surface of the gasket 130 with a cylindrical protrusion structure, or may abut the lower surface of the gasket 130 with a rib structure extending in a cross shape. The cap 150 is fixed to the boss structure 111 at the fixed portion 160, which is inserted and fixed inside the cylindrical shape of the boss structure 111, so that the gasket 130 can be pinched between the abutting portion 112 of the top plate 110 and the cap 150.

The fixed portion 160 is a member that can be inserted into the cylindrical shape of the boss structure 111 and fixed in the inserted state. For example, the fixed portion 160 may be a screw having a screw head larger than the bottom surface of the cylindrical shape of the boss structure 111 and threadedly engaging with a screw groove provided on the inside of the cylindrical shape of the boss structure 111. In addition, the fixed portion 160 may be a retaining pin that fits into a claw hole or a pin hole provided on the inside of the cylindrical shape of the boss structure 111, or may be a retaining pin that is fixed by friction with the inside of the cylindrical shape of the boss structure 111.

Specifically, as shown in FIG. 4, the fixed portion 160 may be a screw that passes through the cap 150 and screws into the cylindrical inside of the boss structure 111. Accordingly, the fixed portion 160 can fasten the cap 150 to the tip of the boss structure 111 by means of a screw head 160A. The cap 150 fastened to the boss structure 111 can be pressed by the screw head 160A of the fixed portion 160 to pinch the gasket 130 between the abutting portion 112 of the top plate 110 and the cap 150.

The bottom cover 120 is a box-shaped member with one side open. The bottom cover 120 is provided on the lower surface side of the top plate 110 and constitutes the chassis on the lower side of the keyboard device 1. Accordingly, the top plate 110 is placed on the bottom cover 120 so as to cover one of the opening sides of the bottom cover 120.

An opening H and the holding portion 121 are provided in the bottom surface of the bottom cover 120. The opening H is provided at a position corresponding to the boss structure 111 of the top plate 110, and forms a space for arranging the gasket 130, the cap 150, and the fixed portion 160. The holding portion 121 is located inside the bottom surface of the bottom cover 120 and holds the gasket 130.

Specifically, the holding portion 121 is constituted by an upper surface holding portion 121A and a lower surface holding portion 121B that protrude from the outside of the opening H toward the inside of the opening H. The holding portion 121 can hold the gasket 130 by sandwiching the upper and lower surfaces of the gasket 130 between the upper surface holding portion 121A and the lower surface holding portion 121B. For example, the holding portion 121 may abut the upper surface of the gasket 130 with the lower surface of the upper surface holding portion 121A provided on the top plate 110 side, and may abut the lower surface of the gasket 130 with the upper surface of the lower surface holding portion 121B provided on the bottom cover 120 side.

The lower surface of the upper surface holding portion 121A that abuts the gasket 130, and the upper surface of the lower surface holding portion 121B may be provided with at least one protrusion or regions with increased thickness, in order to increase the friction with the gasket 130. According to this, the holding portion 121 can more securely hold the gasket 130 between the upper surface holding portion 121A and the lower surface holding portion 121B, thereby preventing the gasket 130 from moving between the upper surface holding portion 121A and the lower surface holding portion 121B.

In addition, as shown in FIG. 5, the upper surface holding portion 121A and the lower surface holding portion 121B may hold the gasket 130 in different regions. That is, the upper surface holding portion 121A and the lower surface holding portion 121B may be provided so as to protrude into regions of the opening H that do not overlap with each other when the opening H is viewed from the front. Specifically, the upper surface holding portion 121A may be provided so as to protrude from the center of each of the four sides of the rectangular opening H, and the lower surface holding portion 121B may be provided so as to protrude from each of the four corners of the rectangular opening H without overlapping with the upper surface holding portion 121A. According to this, the holding portion 121 can eliminate any overlapping parts in the upward/downward direction, making it possible to easily form the upper surface holding portion 121A and the lower surface holding portion 121B by press molding in the upward/downward direction. By being configured in this shape, the holding portion 121 can reduce the manufacturing cost of the bottom cover 120.

According to the above-mentioned configuration, the keyboard device 1 according to this embodiment can improve the positional degree of freedom of the gasket 130 by providing the gasket 130 corresponding to the boss structure 111 provided at an arbitrary position on the top plate 110. Accordingly, the keyboard device 1 makes it possible to uniformly distribute the rebound of the top plate 110 in response to the push pressure of the key switches 140 across the entire keyboard device 1 by arranging the boss structure 111 and the gasket 130 uniformly throughout the keyboard device 1 (for example, at a total of 5 locations: the center and the four corners when viewed in a plan view). Accordingly, the keyboard device 1 makes it possible to equalize the typing feel of the key switches 140 across the peripheral edge portion and the central portion of the top plate 110.

In addition, the keyboard device 1 can improve design freedom by providing the boss structure 111 and the gasket 130 between the key switches 140 and reducing the structure of the peripheral edge portion required to provide the gasket 130.

Further, the keyboard device 1 allows one of the gaskets 130 to be sandwiched between the abutting portion 112 of the top plate 110, the cap 150, and the holding portion 121 of the bottom cover 120. Accordingly, the keyboard device 1 can reduce the number of gaskets 130 because the push pressure between the abutting portion 112 of the top plate 110, the cap 150 and the bottom cover 120 can be cushioned by one of the gaskets 130. Accordingly, the keyboard device 1 can reduce manufacturing costs and improve ease of assembly during manufacturing.

While the preferred embodiment of the present disclosure has been described in detail above with reference to the accompanying drawings, the present disclosure is not limited to such examples. Obviously, a person with ordinary knowledge in the technical field to which the present disclosure pertains can conceive various modifications and variations within the scope of the technical idea set forth in the claims. It should be understood that these modifications and variations naturally pertain to the technical scope of the present disclosure.

What is claimed is:

1. A keyboard device comprising:
a top plate with a plurality of key switches attached to an upper surface thereof;
a bottom cover provided on a lower surface side of the top plate and constituting a chassis on a lower side; and
a gasket configured to hold the upper surface and the lower surface using a holding portion provided inside a bottom surface of the bottom cover,
wherein a boss structure extending in a thickness direction of the chassis is provided on the lower surface of the top plate, and an abutting portion that abuts against the upper surface of the gasket is provided on the outside of the boss structure.

2. The keyboard device according to claim 1, wherein the boss structure is provided to pass through the gasket.

3. The keyboard device according to claim 2, further comprising:
a cap provided to cover a tip of the boss structure; and
a fixed portion inserted into the boss structure and configured to fix the cap to the boss structure.

4. The keyboard device according to claim 3, wherein the cap abuts the lower surface of the gasket, and
the gasket is pinched between the abutting portion and the cap.

5. The keyboard device according to claim 1, wherein the boss structure is provided at a position corresponding to the space between the key switches, which are planarly arranged on the upper surface of the top plate, and
the abutting portion extends from the outside of the boss structure between the key switches.

6. The keyboard device according to claim 5, wherein the boss structure is provided at a position corresponding to the space between two, three, or four of the key switches.

7. The keyboard device according to claim 1, wherein the holding portion holds the gasket in different regions on its upper and lower surfaces.
